(19) United States
(12) Patent Application Publication
(10) Pub. No.: US 2003/0098885 A1
(43) Pub. Date: May 29, 2003

(54) Scroll control device, method for use in said scroll control device, and communication terminal using said scroll control device

(75) Inventor: Masato Yabe, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/298,812

(22) Filed: Nov. 18, 2002

(30) Foreign Application Priority Data
Nov. 28, 2001 (JP) 2001-361853

(51) Int. Cl. G09G 5/00

(52) U.S. Cl. 345/785

(57) ABSTRACT

A scroll control device for controlling the scroll of a display screen has a scroll key for requesting scrolling and control means for performing control in such a manner that, when the scroll key has been depressed continuously for a predetermined period of time, an automatic scroll mode is made active and, when the scroll key has been further continuously depressed, the automatic scroll speed is further increased.

### FIELD OF THE INVENTION

The invention relates to a scroll control device, a method for use in the scroll control device, a communication terminal using the scroll control device, and a program. More particularly, the invention relates to a scroll control method for controlling the scroll of a display screen in communication terminals such as portable telephones (cellular phones).

### BACKGROUND OF THE INVENTION

Portable communication terminal devices, such as portable telephones and PHS (personal handyphone systems), and, further, PDA (personal digital assistants), generally have the function of viewing Web pages and e-mails on the Internet. The size of the display screen in these portable communication terminal devices is, as a matter of course, limited. Therefore, scroll operation on the display screen is indispensable for a user who utilizes the terminal to view the contents of the Web pages, e-mails or the like, and the frequency of this operation is very high.

The scroll operation of the display screen is generally carried out by depressing an upper direction key or a lower direction key for indicating the scroll direction. In order to diversify the operation or to realize easy operation, various scroll operation methods have been proposed. For example, Japanese Patent Laid-Open No. 59481/2000 (reference 1) discloses a method wherein two switches are provided and used in such a manner that the vertical scroll direction of the display screen is determined in the order of the depression of the two switches and the scroll speed is determined by the interval of the depression of the two switches. Japanese Patent Laid-Open No. 268201/2001 (reference 2) discloses a method wherein a sliding operation part is provided on the side portion of a portable terminal and the scroll direction and the scroll speed are determined by the sliding direction and the sliding quantity of the sliding operating part. Further, Japanese Patent Laid-Open No. 69223/2001 (reference 3) discloses a method wherein a high-speed scroll operation is carried out by depressing a scroll key for a long period of time, i.e., depressing a scroll key for a period of time which is longer than a predetermined period of time.

In the general method wherein the key for indicating the scroll direction is depressed, when large-capacity contents are viewed on a small display screen, the key for indicating the scroll direction should be repeatedly depressed a number of times. This disadvantageously leads to deteriorated operability. Further, in the technique disclosed in reference 1, the scroll direction and speed are determined by the operation order and intervals of two switches. This needs to provide two switches separately from each other. This technique is physically unsuitable for terminals having a small operating face, such as portable telephones.

In the technique disclosed in reference 2, a sliding operation part is provided on the side portion of the terminal, and the scroll direction and quantity are determined by the sliding direction and quantity of the sliding operation part. Also in this case, a dedicated sliding operation part should be provided, and, thus, this technique is physically unsuitable for terminals having a small operating face. In the technique disclosed in reference 3, when the scroll key is depressed for a long period of time, high-speed scrolling is carried out. In ordinary depression of the scroll key, that is, when the scroll key is not depressed for a long period of time, the screen is vertically moved by one step, i.e., by a predetermined given scroll quantity, while, when the scroll key is depressed for a long period of time, high-speed scrolling is carried out. That is, in this technique, only two-stage control composed of ordinary one-step scroll and high-speed scroll is performed. Thus, this technique disadvantageously lacks in diversity of the scroll.

### SUMMARY OF THE INVENTION

Accordingly, it is an object of the invention to provide a scroll control device which can diversify scroll operation using a conventional key for indicating the scroll direction, i.e., indicating scroll in the vertical direction, without the need to additionally provide a special dedicated key, a method for use in the scroll control device, and a communication terminal using the scroll control device.

It is another object of the invention to provide a scroll control device with improved operability using only an operation method which is generally an extension of operation called “long depression” of the scroll direction key, a method for use in the scroll control device, and a communication terminal using the scroll control device.

According to the first feature of the invention, a scroll control device for controlling the scroll of a display screen comprises: a scroll key for requesting scrolling; and control means for performing control in such a manner that, when the scroll key has been depressed continuously for a predetermined period of time, an automatic scroll mode is made active and, when the scroll key has been further continuously depressed, the automatic scroll speed is further increased.

In the scroll control device, preferably, the control means increases the automatic scroll speed according to the duration of depression of the scroll key. Preferably, the control means stops the automatic scrolling in response to the depression of a key other than the scroll key.

According to the second feature of the invention, a scroll control method for controlling the scroll of a display screen comprises the steps of: performing control in such a manner that, when a scroll key for requesting scrolling has been depressed continuously for a predetermined period of time, an automatic scroll mode is made active (first step); and performing control in such a manner that, when the scroll key has been further continuously depressed, the automatic scroll speed is further increased (second step).

In the scroll control method, preferably, in the second step, the automatic scroll speed is increased according to the duration of depression of the scroll key. Preferably, the step of stopping the automatic scrolling in response to the depression of a key other than the scroll key (third step) is further provided.

According to the third feature of the invention, a program for allowing a computer to execute a scroll control method for controlling the scroll of a display screen comprises the steps of: performing control in such a manner that, when a scroll key for requesting scrolling has been depressed continuously for a predetermined period of time, an automatic scroll mode is made active (first step); and performing control in such a manner that, when the scroll key has been further continuously depressed, the automatic scroll speed is further increased (second step).

According to the fourth feature of the invention, a communication terminal comprises any one of the above scroll control devices.

According to the invention, control is carried out as follows. In response to “long depression” of the scroll direction instruction key, the mode is transferred to an automatic scroll mode. In this state, when the “long depression” of the scroll direction indication key is continued, the scroll speed is increased according to the duration of the long depression. Therefore, the end of the “long depression” in a desired time can realize automatic scrolling at a desired speed. The automatic scroll mode can be released by operating any key other than the scroll direction key. By virtue of this, in the case of large-capacity contents such as Web pages or e-mails, when the view of the contents in its desired portion is contemplated, the need to repeatedly depress the direction key a number of times can be eliminated and the satisfaction of this demand can be realized by simple operation.

### BRIEF DESCRIPTION OF THE DRAWINGS

The invention will be explained in more detail in conjunction with the appended drawings, wherein:

FIG. 1 is a schematic block diagram showing the construction of a preferred embodiment of the invention;

FIG. 2 is a diagram illustrating variables and constants used in a preferred embodiment of the invention;

FIG. 3 is a flow chart showing a part of the operation of a preferred embodiment of the invention;

FIG. 4 is a flow chart showing a part of the operation of a preferred embodiment of the invention; and

FIG. 5 is a flow chart showing a part of the operation of a preferred embodiment of the invention.

### DESCRIPTION OF THE PREFERRED EMBODIMENTS

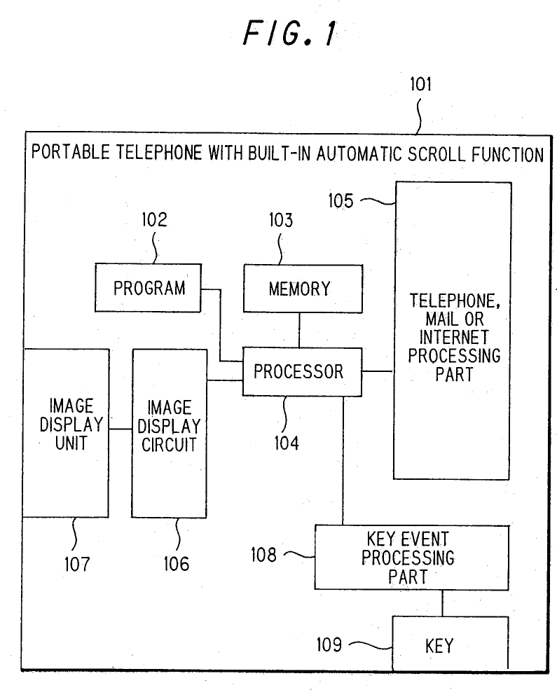

Preferred embodiments of the invention will be explained in detail in conjunction with the accompanying drawings. FIG. 1 shows a schematic diagram showing the construction of a portable telephone 101 with a built-in automatic scroll function in a preferred embodiment of the invention. A key event processing part 108 detects the depression of a key 109 and informs a processor 104 of the detection result. The processor 104 executes the following processing according to a program 102.

As soon as a user depresses the key 109, the key event processing part 108 informs the processor 104 of detection information. When the key is “upper direction” or “lower direction” key, the processor 104 gives, through an image display circuit 106, an instruction such that the display position of the contents is scrolled upward or downward, that is, the display start position is changed, whereby the display of contents in an image display unit 107 is changed.

When the key event continuously occurs and this state is judged to be “long depression” of “upper direction” or “lower direction” key, the processor 104 brings the mode to “automatic scroll mode.” In this “automatic scroll mode,” except for the cases of “head of contents (in the case of upper direction key),” “end of contents (in the case of lower direction key),” and “the depression of a key other than the upper direction or lower direction key,” the screen is automatically scrolled. When the automatic scrolling is desired to be stopped at a desired position, the depression of “a key other than the upper direction or lower direction key” releases the automatic scroll mode to stop the scrolling.

When the long depression state in the upper direction or lower direction key is continued, the scroll speed is increased. When the long depression is ended in a desired time, automatic scrolling at a desired speed can be realized. By virtue of this construction, when contents, which require scrolling, such as Web pages or e-mails, are viewed, this purpose can be accomplished without repeatedly depressing the direction key a number of times for viewing a desired position of the contents.

In FIG. 1, numeral 103 designates a memory, and numeral 105 a processing part for processing actual communication such as telephone (TEL), e-mail, or the Internet.

The preferred embodiment of the invention will be explained in more detail. In FIG. 1, the portable telephone 101 with an automatic scroll function in a preferred embodiment of the invention comprises a key 109 operated by a user, a key event processing part 108 for detecting a key event, a processor 104 for controlling key event processing, image display, and a portable telephone according to a program, a program 102, describing processing of the portable telephone, including a program for allowing the processor 104 to execute automatic scroll processing according to the invention, a memory 103 for providing a working area necessary for executing the program 102 and for storing contents such as e-mails or Web pages, a TEL, e-mail, Internet processing part 105 for performing the TEL function and for acquiring e-mails or Web pages, a screen display circuit 106 for controlling screen display according to the instruction from the processor 104, and an image display unit 107 for allowing a user to view letters and/or images.

According to the program 102, the processor 104 makes a judgment on the key event from the key event processing part 108 and, according to the result of judgment on the key event, in the case of the “long depression of the upper/lower direction key,” performs the transfer of the “automatic scroll mode,” calculation of the scroll quantity based on the time of the “long depression of the upper/lower direction key” at the time of the automatic scroll mode, change of the screen display position based on the scroll quantity, and release of the “automatic scroll mode” and end processing of the scrolling upon the depression of a key other than the “upper/lower direction key.”

It is assumed that, except for the automatic scroll function portion according to the invention included in the program 102, the other program and each device or component are constructed by a conventional technique, and the explanation of the construction and operation thereof will be omitted.

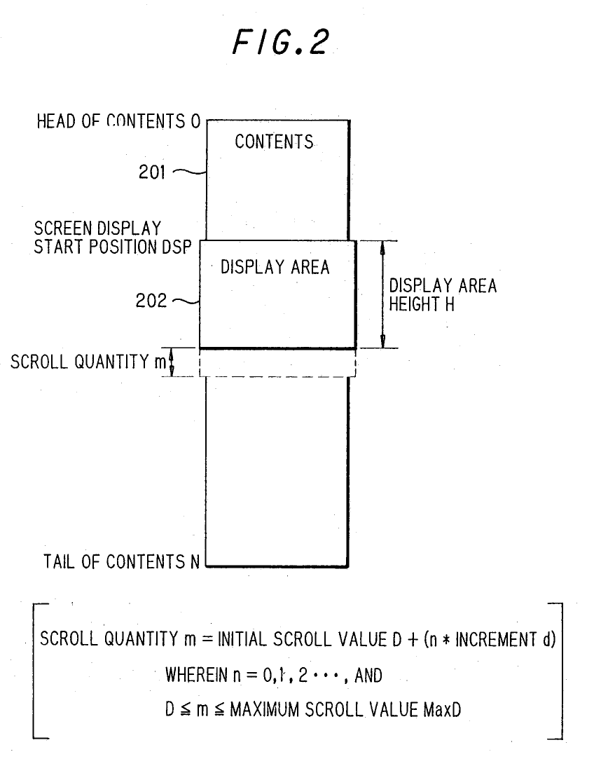

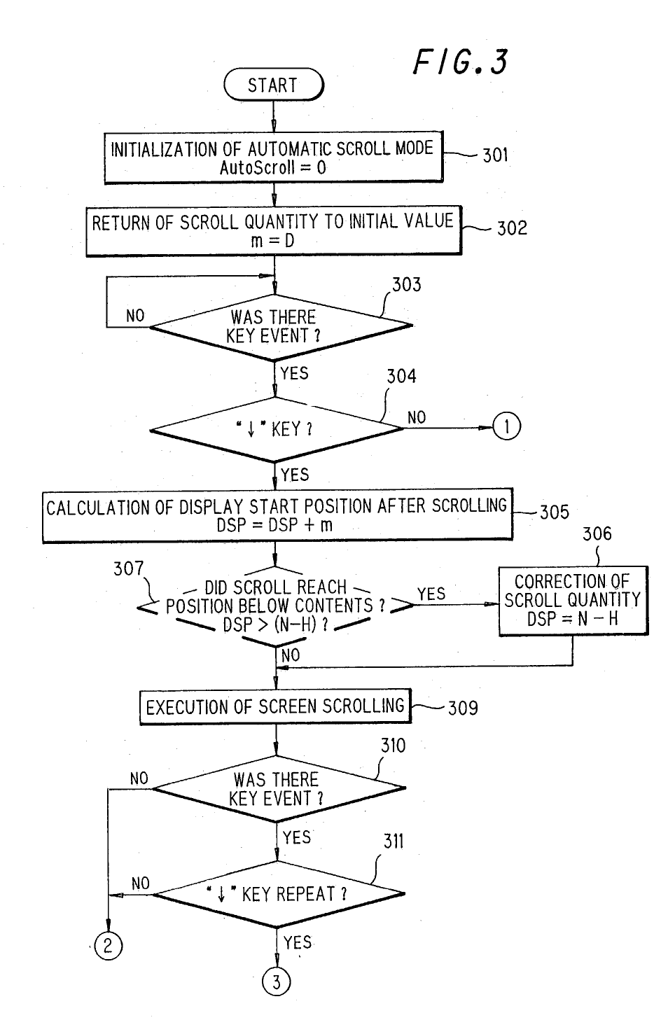

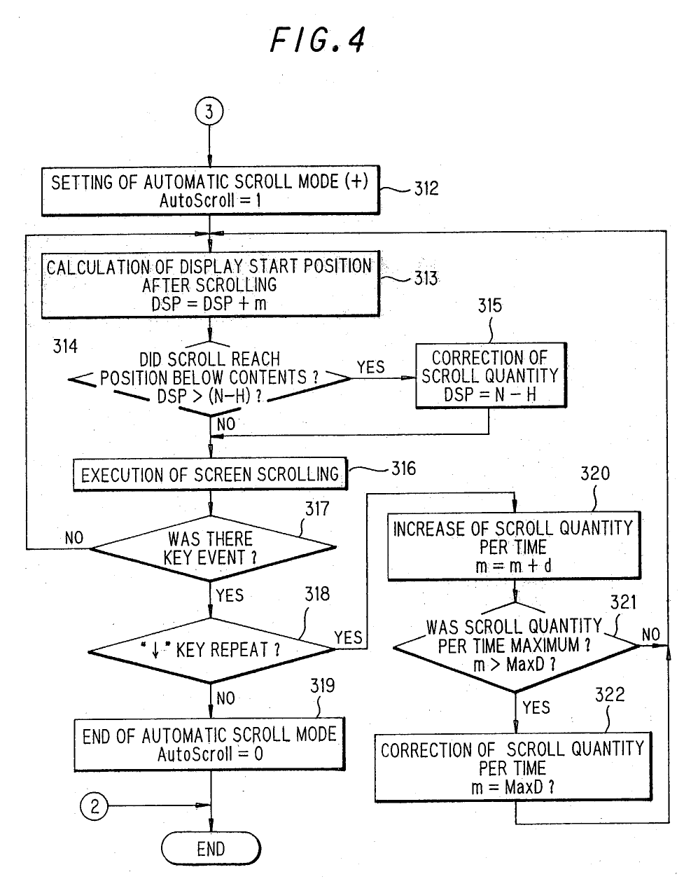

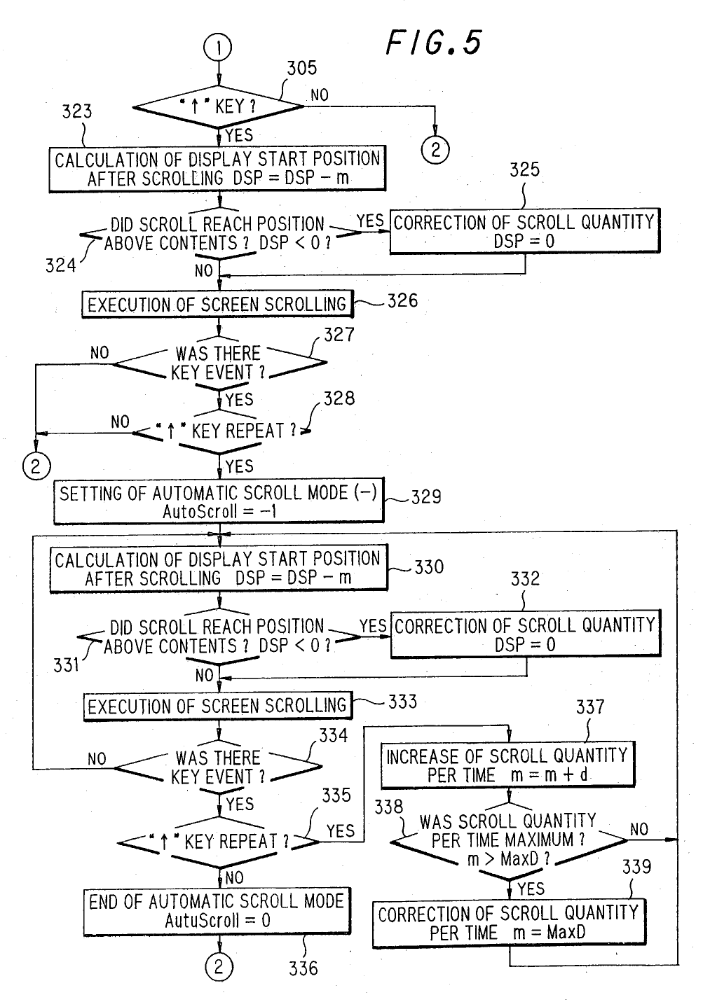

Next, the operation of the automatic scroll function in this preferred embodiment will be explained in detail in conjunction with FIGS. 1 and 2 and flow charts shown in FIGS. 3 to 5. At the outset, variables and constants used in the preferred embodiment will be explained in conjunction with FIG. 2. The length of contents to be displayed, such as Web pages or e-mails, is N. The head of the contents is 0, and the display start position is DSP. The part of the height H from the display start position DSP is a display area which can be seen by the user. The scroll quantity is m, and m can be increased in d increments based on the initial value D of the scroll quantity. The maximum value of the scroll quantity is MaxD, and the single scroll quantity (scroll speed) cannot be increased beyond the MaxD.

Next, the operation will be explained according to the flow charts shown in FIGS. 3 to 5. The processor 104 controls and processes the portable telephone with the function of the invention according to the program 102 as follows. The automatic scroll mode is first initialized (step 301), and the scroll quantity is initialized (step 302). Next, the processor 104 verifies with the key event processing part 108 whether or not there was a key event (step 303). When there was no key event, step 303 is repeated until there is a key event. When there was a key event, the processor 104 verifies whether or not the key is the lower direction key (step 304). When the key is not the lower direction key, the processor 104 verifies whether or not the key is the upper direction key (step 305). When the key is neither the lower direction key nor the upper direction key, the processing is ended.

In step 304, when the result of judgment is that the key is the lower direction key, a calculation is carried out for moving the display start position DSP by m downward (step 306). Based on the result of the calculation, verification is carried out on whether or not the scroll has already reached the end of contents (N−H) (step 307). When the value is larger than (N−H), DSP is corrected to (N−H) (step 308). Based on the result of this calculation, the actual scrolling (change of the display start position) is performed (step 309).

Further, verification of the key event is performed (step 310). When there was no key event, after ordinary single scrolling, the processing is ended. When there was a key event, the processor 104 verifies whether or not the key event is key repetition (long depression) of the lower direction key (step 311). If not so, likewise, after the single scrolling, the processing is ended. On the other hand, in step 311, when the key event has been judged to be long depression of the lower direction key, the automatic scroll mode (direction +) is set (step 312).

Upon setting to the automatic scroll mode, a calculation is carried out for moving the display start position DSP by m downward (step 313). Based on the result of the calculation, verification is carried out on whether or not the scroll has already reached the end of contents (N−H) (step 314). When the value is larger than (N−H) , DSP is corrected to (N−H) (step 315). Based on the result of this calculation, the actual scrolling (change of the display start position) is performed (step 316).

Verification of the key event is further performed (step 317). When there was no key event, steps ranging from step 313 to step 316 are repeated to continuously execute the scroll, i.e., to perform automatic scrolling. On the other hand, in step 317, when there was a key event which was the continuation of the long depression of the lower direction key (step 318), the single scroll quantity m is increased by d (step 320). The processor 104 verifies whether or not the increased scroll quantity m exceeds the maximum scroll quantity MaxD (step 321). When the increased scroll quantity m exceeds the maximum scroll quantity MaxD, the m value is corrected to the MaxD value (step 322) followed by the repetition of automatic scrolling ranging from step 313 to step 316.

That is, since the n value of (n * increment d) in the scroll quantity m shown in FIG. 2 is increased according to the duration of long depression of the lower direction key, the scroll speed increases in proportion to the duration of the long depression.

In step 318, when the key is other than the lower direction key, this is judged to be the end of the automatic scrolling. In this case, the automatic scroll mode is released (step 319) to complete the processing. In step 305, when the key has been judged to be the upper direction key, a calculation is carried out for moving the display start position DSP by m upward (step 323). Based on the result of the calculation, verification is carried out on whether or not the scroll has already reached the head (0) of the contents (step 324). When the value is smaller than (0), DSP is corrected to (0) (step 325). Based on the result of this calculation, actual scrolling (change of display start position) is performed (step 326).

Further, verification of the key event is performed (step 327). When there was no key event, after ordinary single scrolling, the processing is ended. When there was a key event, the processor 104 verifies whether or not the key event is key repetition (long depression) of the upper direction key (step 328). If not so, likewise, after the single scrolling, the processing is ended. On the other hand, in step 328, when the key event has been judged to be long depression of the upper direction key, the automatic scroll mode (direction −) is set (step 329).

Upon setting to the automatic scroll mode, a calculation is carried out for moving the display start position DSP by m upward (step 330). Based on the result of the calculation, verification is carried out on whether or not the scroll has already reached the head (0) of contents (step 331). When the value is smaller than (0), DSP is corrected to (0) (step 332). Based on the result of this calculation, the actual scrolling (change of the display start position) is performed (step 333).

Further, verification of the key event is performed (step 334). When there was no key event, the procedure ranging from step 330 to step 333 are repeated to continuously execute the scroll, i.e., perform automatic scrolling. On the other hand, in step 334, when there was a key event which was the continuation of the long-depression of the upper direction key (step 335), the single scroll quantity m is increased by d (step 337). The processor 104 verifies whether or not the increased scroll quantity m exceeds the maximum scroll quantity MaxD (step 338). When the increased scroll quantity m exceeds the maximum scroll quantity MaxD, the m value is corrected to the MaxD value (step 339) followed by the repetition of automatic scrolling ranging from step 330 to step 333.

That is, since the n value of (n * increment d) in the scroll quantity m shown in FIG. 2 is increased according to the duration of long depression of the upper direction key, the scroll speed increases in proportion to the duration of the long depression.

In step 335, when the key is other than the lower direction key, this is judged to be the end of the automatic scrolling. In this case, the automatic scroll mode is released (step 336) to complete the processing.

It will be appreciated that the flow of the operation shown in FIGS. 3 to 5 can be realized by previously storing this flow as the program 102 in a recording medium and reading and executing the program 102 by the processor 104 as a computer.

It is a matter of course that the invention can be applied to portable terminals, such as portable telephones or PHS and, in addition, PDA, as well as to information processing terminals, such as portable personal computers, which have a limited display screen size and are equipped with communication function.

As described above, in a portable terminal having a limited small display screen size for allowing a user to view contents such as e-mails and Web pages, under an environment wherein, in the prior art technique, frequent scrolling is necessary, that is, the scroll direction key should be depressed a number of times, unlike the prior art technique, according to the invention, desired selection of automatic scrolling and scroll speed can be realized by an operation method which is generally an extension of operation called “long depression” of the upper/lower direction key. Therefore, the user's labor involved in the scroll operation can be advantageously reduced.

Further, according to the invention, in the state of automatic scrolling, the scroll speed can be freely varied by varying the “duration of long depression of the direction key.” Therefore, even in the case of the display of contents which requires a large quantity of scrolling, scrolling to a desired position can be realized in a short time. The change in scroll speed can be advantageously performed by an identical key only.

The invention has been described in detail with particular reference to preferred embodiments, but it will be understood that variations and modifications can be effected within the scope of the invention as set forth in the appended claims.

What is claimed is:

1. A scroll control device for controlling the scroll of a display screen, comprising:
a scroll key for requesting scrolling; and
control means for performing control in such a manner that, when the scroll key has been depressed continuously for a predetermined period of time, an automatic scroll mode is made active and, when the scroll key has been further continuously depressed, the automatic scroll speed is further increased.

2. The scroll control device according to claim 1, wherein the control means increases the automatic scroll speed according to the duration of depression of the scroll key.

3. The scroll control device according to claim 1, wherein the control means stops the automatic scrolling in response to the depression of a key other than the scroll key.

4. The scroll control device according to claim 2, wherein the control means stops the automatic scrolling in response to the depression of a key other than the scroll key.

5. A communication terminal comprising the scroll control device according to claim 1.

6. A communication terminal comprising the scroll control device according to claim 2.

7. A communication terminal comprising the scroll control device according to claim 3.

8. A communication terminal comprising the scroll control device according to claim 4.

9. A scroll control method for controlling the scroll of a display screen, comprising the steps of:
performing control in such a manner that, when a scroll key for requesting scrolling has been depressed continuously for a predetermined period of time, an automatic scroll mode is made active (first step); and
performing control in such a manner that, when the scroll key has been further continuously depressed, the automatic scroll speed is further increased (second step).

10. The scroll control method according to claim 9, wherein, in the second step, the automatic scroll speed is increased according to the duration of depression of the scroll key.

11. The scroll control method according to claim 9 or 10, which further comprises the step of stopping the automatic scrolling in response to the depression of a key other than the scroll key (third step).

12. A program for allowing a computer to execute a scroll control method for controlling the scroll of a display screen, said program comprising the steps of:
performing control in such a manner that, when a scroll key for requesting scrolling has been depressed continuously for a predetermined period of time, an automatic scroll mode is made active (first step); and
performing control in such a manner that, when the scroll key has been further continuously depressed, the automatic scroll speed is further increased (second step).
